(19) United States
(12) Patent Application Publication
(10) Pub. No.: US 2009/0302021 A1
(43) Pub. Date: Dec. 10, 2009

(54) Method for Making A Glow Element, A Spark Element, or A Heating Element for A Combustion Device and/or A Heating Device, and Device Thereof

(76) Inventors: Martin Koehne, Asperg (DE); Alexander Klonczynski, Bamberg (DE)

Correspondence Address: KENYON & KENYON LLP, ONE BROADWAY, NEW YORK, NY, 10004, US

(21) Appl. No.: 12/087,026

(22) PCT Filed: Nov. 15, 2006
(86) PCT No.: PCT/EP2006/068490

§ 371 Date: Mar. 25, 2009

(30) Foreign Application Priority Data
Dec. 23, 2005 (DE) 102005062115.5

(51) Int. Cl. F23Q 7/00; B05D 5/12

(52) U.S. Cl. 219/260; 427/77

(57) ABSTRACT

A method for making a glow element, a spark element, or a heating element for combustion and/or heating devices, in particular a glow plug, a spark plug, or a heater, having a corrosion-protective coating for parts of the glow element, spark element, or heating element having a silicon-containing ceramic, and the element thereof. The corrosion-protective coating is composed of a mixture of SiO₂ and at least one other substance.

### FIELD OF THE INVENTION

The present invention relates to a glow element, spark element, or heating element for combustion and/or heating devices.

### BACKGROUND INFORMATION

Glow elements, spark elements, or heating elements for combustion and/or heating devices are manufactured of ceramic composite materials for high heat resistance. Normally these base bodies are made of silicon-containing ceramic and have an oxidation-resistant SiO₂ protective coating, which protects the base body to a large extent against reactions with substances with which the particular element comes into contact during its time of operation. Under extreme conditions of use, however, conditions may arise that make an attack on the essentially oxidation-resistant SiO₂ protective coating possible. In particular, high temperatures in combination with the occurrence of certain substances or compounds such as high-pressure hot steam, corrosive oxide slags such as Na₂O, V₂O₅, CaO, KO₂, and others, as well as sulfur and sulfur compounds which result in the formation of corrosive SO₂ and SO₃, are critical.

To overcome these issues, the application of a tantalum oxide protective coating for a ceramic heater is discussed in U.S. Pat. No. 5,578,349, which is incorporated by reference as to a representative ceramic heater. Tantalum oxide, however, is reduced according to the equation Ta₂O₅+7C→2TaC+5CO at temperatures higher than approximately 1,100° C. in contact with carbon and thus it is also attacked and, over time, destroyed.

### SUMMARY OF THE INVENTION

An object of the exemplary embodiment and/or exemplary methods of the present invention is to improve the protection of glow elements, spark elements, or heating elements according to the above-mentioned related art.

This object is achieved by the features described herein. Advantageous and useful refinements arise from other features described herein.

Accordingly, the exemplary embodiment and/or exemplary methods of the present invention relates to a glow element, spark element, or heating element for combustion and/or heating devices, in particular a glow plug, a spark plug, or a heater, having a corrosion-protective coating for parts of the glow element, spark element, or heating element having a silicon-containing ceramic. It is characterized in that the corrosion-protective coating is composed of a mixture of SiO₂ and at least one other substance.

The other substance may be, for example, Al₂O₃, ZrO₂, TiO₂, MgO, Y₂O₃, Yb₂O₃, or Er₂O₃. A corrosion-protective coating formed in this way lastingly protects the silicon-containing ceramic base body of the glow element, spark element, or heating element against corrosive or erosive damage during contact with aggressive substances.

By using alkaline and/or alkaline earth metals and/or boron and/or boron compounds and/or zirconium and/or zirconium compounds and/or gallium, indium, silicon, and/or germanium, for example, a particularly stable protective coating may be formed because the admixture of one or more of these additives may positively influence the formation of a greater coating thickness.

The admixture of zirconium oxide stabilized using yttrium oxide may also have a positive effect on such a corrosion-protective coating through its densifying properties. In particular, they may cause the melting point of the SiO₂ to be substantially reduced when the corrosion-protective coating is formed.

The advantages of admixing such additives are, in addition to the additional improvement in the protective effect of the corrosion-protective coating due to their greater density, also cost reduction in the manufacture of the respective elements, among other things, due to the relatively lower temperatures required for the manufacturing process.

An additional positive influence on the protective effect of the corrosion-protective coating may be achieved via controlled influence on the ratio between the size of the SiO₂ particles to that of the particles of one or more of the other base materials or additives forming the corrosion-protective coating. Thus, for example, the use of considerably larger SiO₂ particles compared to the particle size of the other additives has a positive effect in that the SiO₂ particles melt before the particles of the additives do. This may prevent or at least considerably reduce the dissolution of the additives in the SiO₂ particles. The range around a factor 10 between SiO₂ particles and the particles of the additive has been found to be an advantageous size ratio. Of course, however, different ratios may also be possible; they may be larger or smaller, particularly advantageous factor ratios, depending, among other things, on the additives or additive mixtures used.

Depending on the specific embodiment, the protective coating may be directly applied to the ceramic base body or also to an additional protective coating already applied to the ceramic body. For either embodiment, both corrosive and erosive protective effects are obtained for the silicon dioxide-containing ceramic base body. This is advantageous in particular in the case of such glow elements, spark elements, or heating elements that are exposed to high flow loads such as, for example, glow plugs which are situated in the injection area of diesel injection nozzles. Due to the permanent exposure to diesel droplets which are sprayed into the combustion chamber at a high velocity, such ceramic elements are exposed to extreme loads, and their protection may be considerably improved by the corrosion protection coating and/or erosion protection coating according to the exemplary embodiment and/or exemplary methods of the present invention.

In addition to these functional advantages of the corrosion and erosion protection coating according to the exemplary embodiment and/or exemplary methods of the present invention, the use of the above-mentioned base bodies and additives also offers the possibility of using more advantageous and easier-to-implement manufacturing methods. For example, in a first manufacturing method, a coating made of a mixture of SiO₂ particles and particles of at least one other substance may be applied to the silicon-containing ceramic body, subsequently dried at a temperature of approximately <300° C. and then sintered by heating in the range of approximately 1,250° C. This may be a sintering method.

An advantageous application of temperature for forming the corrosion-protective coating to be thus manufactured could be provided, for example, by increasing the temperature 300 K/h up to an upper temperature range to be maintained for a longer period of time. This upper temperature range may be, for example, in the range around 1,300° C. and the holding period may be approximately 8 h. Subsequently, in a reverse application of temperature, cooling at approximately 300 K/h may follow down to room temperature. This coating to be cured may be applied either on a first protective coating already protecting the silicon-containing ceramic body, in particular a silicon dioxide protective coating, or directly on a ceramic body not having such a protective coating. In forming the corrosion-protective coating according to the exemplary embodiment and/or exemplary methods of the present invention, in addition to sintering the particles forming the substance mixture among each other, sintering onto the surface of the ceramic base body also occurs. This produces both a very stable and solid corrosion-protective coating and a very stable and solid bond between this coating and the ceramic base body of the glow element, spark element, or heating element in question.

An immersion method is advantageously proposed in particular as a method for applying the particle mixture forming the corrosion-protective coating. For this purpose, the particle mixture forming the later corrosion-protective coating is kept ready, in preparation, as a wet or moist sludge, in which the corresponding, silicon-containing ceramic body is simply immersed for coating and subsequently removed. A largely uniform thickness and a coating tightly enveloping the ceramic body are thus formed.

Another option for an immersion method is to provide a dry particle mixture into which the ceramic body to be coated is immersed and subsequently removed again. Depending on the method, different adhesion forces are used here, which provide a predominantly uniform coating thickness on the ceramic body such as, for example, electrostatic attractive forces and/or via the cross-linking properties of at least one component of the particle mixture during contact with the heated ceramic body.

### DETAILED DESCRIPTION

The exemplary embodiment and/or exemplary methods of the present invention is elucidated in greater detail on the basis of the exemplary embodiment described below.

One possible procedure for manufacturing a corrosion-protective coating according to the present invention for a silicon-containing ceramic base body of a glow element, spark element, or heating element is to manufacture a mixture of pyrogenic silica and very fine quartz powder and pyrogenic aluminum oxide, which is prepared by adding a solvent to a suspension. Such suspensions are known, for example, as coating precursors. This coating precursor is applied to the silicon-containing ceramic base bodies of the glow element, spark element, or heating element, which may be by the immersion method. The coating precursor is dried at temperatures of <approximately 300° C., which is followed by a heat treatment for forming a ceramic protection layer at relatively low temperatures in the range of approximately 1,250° C. and higher.

A 15-percent aqueous solution of LiOH may be used, for example, as a solvent. The compound may contain, for example, 73% ultrafine quartz powder, 0.6% pyrogenic silica, and 26.4% pyrogenic aluminum oxide. This compound present in powder form is thoroughly mixed and treated with the solvent.

The individual components may have the following properties, for example:
Ultrafine quartz powder: −BET 16 m²/g, d₈₅=1 μm
Pyrogenic silica: −BET 50 m²/g, primary particle size: 40 nm
Pyrogenic aluminum oxide: −BET 100 m²/g, primary particle size: 13 nm

In a modified specific embodiment, 1% by mass of boron oxide may be added to the above-described compound under thorough agitation. This powder mixture may be mixed, for example, with isopropanol in a ratio of 1:30 to provide another coating precursor in which the silicon-containing ceramic base body of the corresponding element may be immersed. Using such a coating precursor, a further corrosion-protective coating to be formed, which bonds relatively well with the SiO₂ protective layer, may be applied, according to the exemplary embodiment and/or exemplary methods of the present invention, to an existing SiO₂ protective coating.

An even better bond between the corrosion-protective coating to be produced and the silicon-containing base body is obtained when it is applied to an uncoated silicon-containing ceramic base body, because particularly solid bonds are formed in this case between the corrosion-protective coating to be formed and the ceramic base body. If the ceramic body is not wetted, the coating precursor may also be modified using a surface-active substance.

Another possible variant for producing a corrosion-protective coating according to the exemplary embodiment and/or exemplary methods of the present invention for a silicon-containing ceramic base body is to mix 90% by mass silicic acid ester with 10% by mass pyrogenic silica.

To obtain specific properties for these coating precursors, the particular powder mixtures may be treated, in a controlled manner, with further additives or mixtures mentioned above. The formation of the coatings applied to the particular ceramic body which may be by immersion methods may take place in all methods as described above. However, independently therefrom, other methods are also possible, such as:
CVD (chemical vapor deposition)
PVD (physical vapor deposition)
thermal spray
plasma spray
spraying methods (such as air brushing)
printing methods (such as screen printing)
centrifugal methods (such as spin coating)

1-13. (canceled)

14. An element for at least one of a combustion device and a heating device, comprising:
an element, which is one of a glow plug, a spark plug, and a heater, that has parts;
wherein parts having a silicon-containing ceramic of the element are treated with a corrosion-protective coating, and wherein the corrosion-protective coating includes a mixture of SiO₂ and at least one other substance.

15. The element of claim 14, wherein the at least one other substance is one of Al₂O₃, ZrO₂, TiO₂, MgO, Y₂O₃, Yb₂O₃, and Er₂O₃.

16. The element of claim 14, wherein the corrosion-protective coating has at least one of (i) alkaline, (ii) alkaline earth metals, (iii) boron, (iv) boron compounds, (v) zirconium, (vi) zirconium compounds, (vii) gallium, (viii) indium, (ix) silicon, and (x) germanium.

17. The element of claim 14, wherein the corrosion-protective coating has zirconium oxide stabilized with yttrium oxide.

18. The element of claim 14, wherein a size ratio between SiO₂ particles and particles of one of the other substances of the corrosion-protective coating is approximately in a range of 10:1.

19. The element of claim 14, wherein the corrosion-protective coating is applied directly to a ceramic base body.

20. The element of claim 14, wherein the corrosion-protective coating is applied to another protective coating formed on a ceramic base body.

21. The element of claim 14, wherein the corrosion-protective coating provides erosion protection.

22. A method for manufacturing one of a glow element, a spark element, and a heating element, the method comprising:
applying a coating made of a mixture of SiO₂ particles and particles of at least one other substance to a silicon-containing ceramic body of the element;
drying the coating at a temperature of less than approximately 300° C.; and
sintering the coating by heating it to over 1,250° C.

23. The method of claim 22, wherein the coating applied to the silicon-containing ceramic body is heated at approximately 300 K/h for curing to a temperature of approximately 1300° C., which is maintained for approximately 8 hours, and is subsequently cooled at approximately 300 K/h to room temperature.

24. The method of claim 22, wherein the coating is subjected to a heat treatment together with the silicon-containing ceramic body.

25. The method of claim 22, wherein the coating is cured subsequently to the silicon-containing ceramic body.

26. The method of claim 22, wherein the coating is applied to the silicon-containing ceramic body by an immersion method.

27. The method of claim 22, wherein the at least one other substance includes one of Al₂O₃, ZrO₂, TiO₂, MgO, Y₂O₃, Yb₂O₃, and Er₂O₃.

28. The method of claim 22, wherein the corrosion-protective coating has at least one of (i) alkaline, (ii) alkaline earth metals, (iii) boron, (iv) boron compounds, (v) zirconium, (vi) zirconium compounds, (vii) gallium, (viii) indium, (ix) silicon, and (x) germanium.

29. The method of claim 22, wherein the corrosion-protective coating has zirconium oxide stabilized with yttrium oxide.

30. The method of claim 22, wherein a size ratio between SiO₂ particles and particles of one of the other substances of the corrosion-protective coating is approximately in a range of 10:1.

31. The method of claim 22, wherein the corrosion-protective coating is applied directly to the ceramic base body.

32. The method of claim 22, wherein the corrosion-protective coating is applied to another protective coating formed on the ceramic body.

33. The method of claim 22, wherein the corrosion-protective coating provides erosion protection.
